(19) United States
(12) Patent Application Publication
(10) Pub. No.: US 2019/0394619 A1
(43) Pub. Date: Dec. 26, 2019

(54) METHOD AND SYSTEM FOR ACCESS TO EMBMS SERVICES

(71) Applicant: QUALCOMM Incorporated, San Diego, CA (US)

(72) Inventors: Ralph Akram Gholmieh, San Diego, CA (US); Ankur Verma, San Diego, CA (US); Hans Agardh, La Jolla, CA (US)

(21) Appl. No.: 16/445,912

(22) Filed: Jun. 19, 2019

Related U.S. Application Data
(60) Provisional application No. 62/689,033, filed on Jun. 22, 2018.

(51) Int. Cl. H04W 4/06; H04L 29/08

(52) U.S. Cl. CPC H04W 4/06; H04L 12/189; H04L 67/06

(57) ABSTRACT

A method, system, and apparatus for transferring mission-critical data from an application. The method includes receiving a first service announcement file from a MBMS middleware, the first service announcement file describing services of interest to the application including a file delivery service, providing a second service announcement file to the MBMS middleware, the second service announcement file describing at least one service provided by the application including a file delivery interface, registering the application, the file delivery interface, and the file delivery service at the MBMS middleware, and directly providing content delivered by the file delivery service received at the file delivery interface to the application.

This application claims the benefit of U.S. Provisional Patent Application No. 62/689,033 filed Jun. 22, 2018, which is hereby incorporated by reference in its entirety.

### BACKGROUND

The present disclosure relates generally to evolved Multimedia Broadcast Multicast Service (MBMS) (eMBMS) services, and more particularly to eMBMS middleware.

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of an emerging telecommunication standard is Long Term Evolution (LTE). LTE is a set of enhancements to the Universal Mobile Telecommunications System (UMTS) mobile standard promulgated by Third Generation Partnership Project (3GPP). LTE is designed to better support mobile broadband Internet access by improving spectral efficiency, lowering costs, improving services, making use of new spectrum, and better integrating with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in 3G, 4G, LTE and beyond technologies. Preferably, these improvements should be applicable to other multi-access technologies and the telecommunication standards that employ these technologies.

### SUMMARY

In one example embodiment, a method for receiving priority data at an application is discussed. The method includes receiving a first service announcement file from a Multimedia Broadcast Multicast Service (MBMS) middleware, the first service announcement file describing services of interest to the application including a file delivery service, providing a second service announcement file to the MBMS middleware, the second service announcement file describing at least one service provided by the application including a file delivery interface, requesting to register the application, the file delivery interface, and the file delivery service at the MBMS middleware, and directly providing content delivered by the file delivery service received at the file delivery interface to the application. The file delivery service may be associated with a mission-critical data service through an associated service identifier. The method includes providing a service list to the MBMS middleware, the service list including the mission-critical data service, and requesting, by the application, files of interest for subsequent download and delivery via the mission-critical data service. The method includes combining the service list with the first service announcement file and the second service announcement file into a global service announcement, and providing the global service announcement to the MBMS middleware. The method includes providing the file delivery service with higher-priority service level over other services provided by the application and the MBMS middleware. The content may be received from a multicast IP socket associated with the file delivery interface and a group call client. The MBMS middleware may support a group call system application server. The method includes responsive to determining an associated expiry time has elapsed, requesting to unregister the application, the file delivery interface, and the file delivery service at the MBMS middleware.

In another example embodiment, an apparatus for receiving priority data at an application is discussed. The apparatus includes a memory for storing the application, a communications interface in communication with a Multimedia Broadcast Multicast Service (MBMS) middleware, and a processor coupled to the memory and the communications interface, the processor configured to, receive a first service announcement file from the MBMS middleware, the first service announcement file describing services of interest to the application including a file delivery service, provide a second service announcement file to the MBMS middleware, the second service announcement file describing at least one service provided by the application including a file delivery interface, request to register the application, the file delivery interface, and the file delivery service at the MBMS middleware, and directly providing content delivered by the file delivery service received at the file delivery interface to the application. The file delivery service may be associated with a mission-critical data service through an associated service identifier. The processor is further configured to, provide a service list to the MBMS middleware, the service list including the mission-critical data service, and request, by the application, files of interest for subsequent download and delivery via the mission-critical data service. The processor is further configured to, combine the service list with the first service announcement file and the second service announcement file into a global service announcement, and provide the global service announcement to the MBMS middleware. The processor is further configured to, provide the file delivery service with higher-priority service level over other services provided by the application and the MBMS middleware. The content may be received from a multicast IP socket associated with the file delivery interface and a group call client. The MBMS middleware may support a group call system application server. The processor is further configured to, responsive to determining an associated expiry time has elapsed, request to unregister the application, the file delivery interface, and the file delivery service at the MBMS middleware.

In another example embodiment, an apparatus for receiving priority data at an application is discussed. The apparatus includes a memory means for storing the application, a communications interface means in communication with a Multimedia Broadcast Multicast Service (MBMS) middleware, and a processor means coupled to the memory and the communications interface, the processor means configured to, receive a first service announcement file from the MBMS middleware, the first service announcement file describing services of interest to the application including a file delivery service, provide a second service announcement file to the MBMS middleware, the second service announcement file describing at least one service provided by the application including a file delivery interface, request to register the application, the file delivery interface, and the file delivery service at the MBMS middleware, and directly providing content delivered by the file delivery service received at the file delivery interface to the application. The file delivery service may be associated with a mission-critical data service through an associated service identifier. The processor means is further configured to, provide a service list to the MBMS middleware, the service list including the mission-critical data service, and request, by the application, files of interest for subsequent download and delivery via the mission-critical data service. The processor means is further configured to, combine the service list with the first service announcement file and the second service announcement file into a global service announcement, and provide the global service announcement to the MBMS middleware. The processor means is further configured to, provide the file delivery service with higher-priority service level over other services provided by the application and the MBMS middleware. The content may be received from a multicast IP socket associated with the file delivery interface and a group call client. The MBMS middleware may support a group call system application server. The processor means is further configured to, responsive to determining an associated expiry time has elapsed, request to unregister the application, the file delivery interface, and the file delivery service at the MBMS middleware.

In another example embodiment, a non-transitory computer-readable storage medium is discussed, the medium having stored thereon instructions that, when executed, cause one or more processors to perform a process. The process includes receiving a first service announcement file from a Multimedia Broadcast Multicast Service (MBMS) middleware, the first service announcement file describing services of interest to the application including a file delivery service, providing a second service announcement file to the MBMS middleware, the second service announcement file describing at least one service provided by the application including a file delivery interface, requesting to register the application, the file delivery interface, and the file delivery service at the MBMS middleware, and directly providing content delivered by the file delivery service received at the file delivery interface to the application. The file delivery service may be associated with a mission-critical data service through an associated service identifier. The process includes providing a service list to the MBMS middleware, the service list including the mission-critical data service, and requesting, by the application, files of interest for subsequent download and delivery via the mission-critical data service. The process includes combining the service list with the first service announcement file and the second service announcement file into a global service announcement, and providing the global service announcement to the MBMS middleware. The process includes providing the file delivery service with higher-priority service level over other services provided by the application and the MBMS middleware. The content may be received from a multicast IP socket associated with the file delivery interface and a group call client. The MBMS middleware may support a group call system application server. The process includes responsive to determining an associated expiry time has elapsed, requesting to unregister the application, the file delivery interface, and the file delivery service at the MBMS middleware.

### BRIEF DESCRIPTION OF THE DRAWINGS

The accompanying drawings, which are incorporated herein and constitute part of this specification, illustrate example embodiments of the claims, and together with the general description given above and the detailed description given below, serve to explain the features of the claims.

FIG. 1 is a diagram illustrating an example of a network architecture

FIG. 2 is a diagram illustrating an example of an access network

FIG. 3 is a diagram illustrating an example of a radio protocol architecture for the user and control planes

FIG. 4 is a diagram illustrating an exemplary eMBMS end-to-end architecture

FIG. 5 is a diagram illustrating different exemplary eMBMS end-to-end architecture

FIG. 6 is a schematic diagram illustrating components of a computing device.

FIG. 7 illustrates example eMBMS Protocol Layers in an exemplary device.

FIG. 8 illustrates an example network architecture.

FIG. 9 illustrates example process supporting the priority data transfer.

FIG. 10 illustrates an example call flow.

FIG. 11 illustrates an example MSDC interface for handling Group Calls.

### DETAILED DESCRIPTION

Various embodiments will be described in detail with reference to the accompanying drawings. Whenever possible, the same reference numbers will be used throughout the drawings to refer to the same or like parts. References made to particular examples and implementations are for illustrative purposes and are not intended to limit the scope of the claims. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of mobile devices will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

Also, the terms “communications device” and “computing device” are used interchangeably herein to refer to any one or all of cellular telephones, smart phones, smart watches or wearables, personal or mobile multi-media players, personal data assistants (PDAs), laptop computers, tablet computers, smart books, palm-top computers, wireless electronic mail receivers, multimedia Internet enabled cellular telephones, wireless gaming controllers, and similar personal electronic devices that include at least a processor. Various embodiments would also include a memory and/or storage as well as circuitry for establishing wireless communications pathways and transmitting/receiving data via wireless communications pathways.

Communications devices may use a variety of interface technologies, such as wired interface technologies (e.g., Universal Serial Bus (USB) connections, etc.) and/or air interface technologies (also known as radio access technologies) (e.g., Third Generation (3G), Fourth Generation (4G), Long Term Evolution (LTE), Edge, Bluetooth, Wi-Fi, satellite, etc.). Communications devices may establish connections to a network, such as the Internet, via more than one of these interface technologies at the same time (e.g., simultaneously). For example, a mobile communications device may establish an LTE network connection to the Internet via a cellular tower or a base station at the same time that the mobile communications device may establish a wireless local area network (WLAN) network connection (e.g., a Wi-Fi network connection) to an Internet connected Wi-Fi access point.

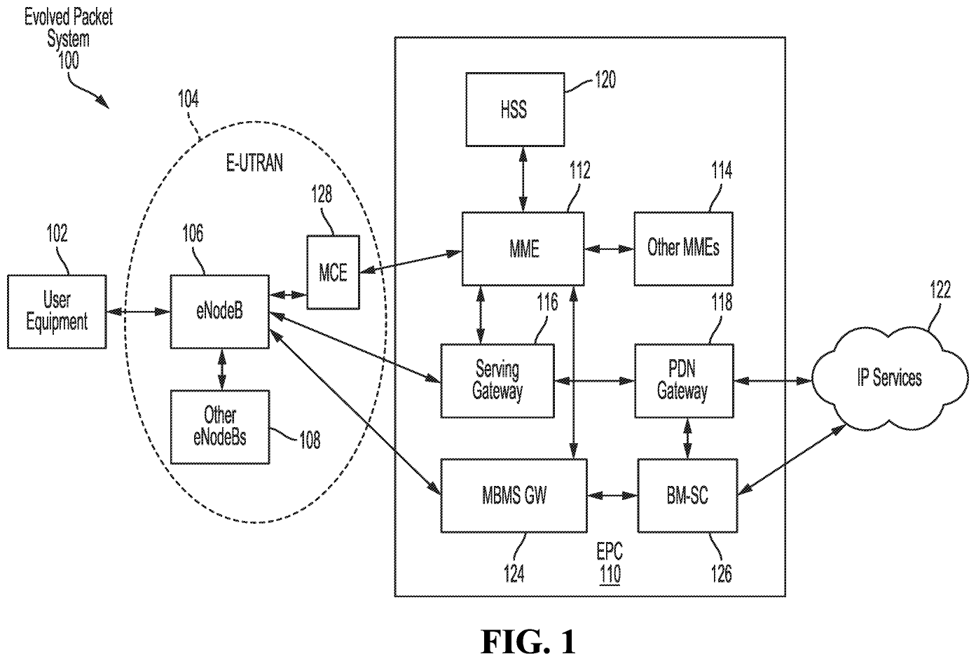

FIG. 1 is a diagram illustrating an LTE network architecture 100. The LTE network architecture 100 may be referred to as an Evolved Packet System (EPS) 100. The EPS 100 may include one or more user equipment (UE) 102, an Evolved UMTS Terrestrial Radio Access Network (E-UTRAN) 104, an Evolved Packet Core (EPC) 110, and an Operator's Internet Protocol (IP) Services 122. The EPS can interconnect with other access networks, but for simplicity those entities/interfaces are not shown. As shown, the EPS provides packet-switched services, however, as those skilled in the art will readily appreciate, the various concepts presented throughout this disclosure may be extended to networks providing circuit-switched services.

The E-UTRAN includes the evolved Node B (eNB) 106 and other eNBs 108, and may include a Multicast Coordination Entity (MCE) 128. The eNB 106 provides user and control planes protocol terminations toward the UE 102. The eNB 106 may be connected to the other eNBs 108 via a backhaul (e.g., an X2 interface). The MCE 128 allocates time/frequency radio resources for evolved Multimedia Broadcast Multicast Service (MBMS) (eMBMS), and determines the radio configuration (e.g., a modulation and coding scheme (MCS)) for the eMBMS. The MCE 128 may be a separate entity or part of the eNB 106. The eNB 106 may also be referred to as a base station, a Node B, an access point, a base transceiver station, a radio base station, a radio transceiver, a transceiver function, a basic service set (BSS), an extended service set (ESS), or some other suitable terminology. The eNB 106 provides an access point to the EPC 110 for a UE 102. Examples of UEs 102 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, or any other similar functioning device. The UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNB 106 is connected to the EPC 110. The EPC 110 may include a Mobility Management Entity (MME) 112, a Home Subscriber Server (HSS) 120, other MMEs 114, a Serving Gateway 116, a Multimedia Broadcast Multicast Service (MBMS) Gateway 124, a Broadcast Multicast Service Center (BM-SC) 126, and a Packet Data Network (PDN) Gateway 118. The MME 112 is the control node that processes the signaling between the UE 102 and the EPC 110. Generally, the MME 112 provides bearer and connection management. All user IP packets are transferred through the Serving Gateway 116, which itself is connected to the PDN Gateway 118. The PDN Gateway 118 provides UE IP address allocation as well as other functions. The PDN Gateway 118 and the BM-SC 126 are connected to the IP Services 122. The IP Services 122 may include the Internet, an intranet, an IP Multimedia Subsystem (IMS), a PS Streaming Service (PSS), and/or other IP services. The BM-SC 126 may provide functions for MBMS user service provisioning and delivery. The BM-SC 126 may serve as an entry point for content provider MBMS transmission, may be used to authorize and initiate MBMS Bearer Services within a PLMN, and may be used to schedule and deliver MBMS transmissions. The MBMS Gateway 124 may be used to distribute MBMS traffic to the eNBs (e.g., 106, 108) belonging to a Multicast Broadcast Single Frequency Network (MBSFN) area broadcasting a particular service, and may be responsible for session management (start/stop) and for collecting eMBMS related charging information.

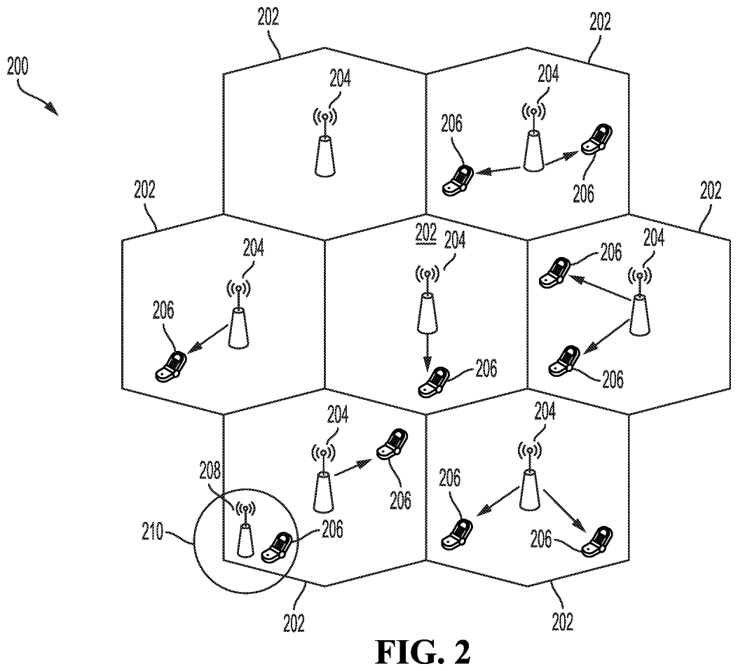

FIG. 2 is a diagram illustrating an example of an access network 200 in an LTE network architecture. In this example, the access network 200 is divided into a number of cellular regions (cells) 202. One or more lower power class eNBs 208 may have cellular regions 210 that overlap with one or more of the cells 202. The lower power class eNB 208 may be a femto cell (e.g., home eNB (HeNB)), pico cell, micro cell, or remote radio head (RRH). The macro eNBs 204 are each assigned to a respective cell 202 and are configured to provide an access point to the EPC 110 for all the UEs 206 in the cells 202. There is no centralized controller in this example of an access network 200, but a centralized controller may be used in alternative configurations. The eNBs 204 are responsible for all radio related functions including radio bearer control, admission control, mobility control, scheduling, security, and connectivity to the serving gateway 116. An eNB may support one or multiple (e.g., three) cells (also referred to as a sectors). The term “cell” can refer to the smallest coverage area of an eNB and/or an eNB subsystem serving are particular coverage area. Further, the terms “eNB,” “base station,” and “cell” may be used interchangeably herein.

The modulation and multiple access scheme employed by the access network 200 may vary depending on the particular telecommunications standard being deployed. In LTE applications, OFDM is used on the DL and SC-FDMA is used on the UL to support both frequency division duplex (FDD) and time division duplex (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNBs 204 may have multiple antennas supporting MIMO technology. The use of MIMO technology enables the eNBs 204 to exploit the spatial domain to support spatial multiplexing, beamforming, and transmit diversity. Spatial multiplexing may be used to transmit different streams of data simultaneously on the same frequency. The data streams may be transmitted to a single UE 206 to increase the data rate or to multiple UEs 206 to increase the overall system capacity. This is achieved by spatially precoding each data stream (i.e., applying a scaling of an amplitude and a phase) and then transmitting each spatially precoded stream through multiple transmit antennas on the DL. The spatially precoded data streams arrive at the UE(s) 206 with different spatial signatures, which enables each of the UE(s) 206 to recover the one or more data streams destined for that UE 206. On the UL, each UE 206 transmits a spatially precoded data stream, which enables the eNB 204 to identify the source of each spatially pre-coded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

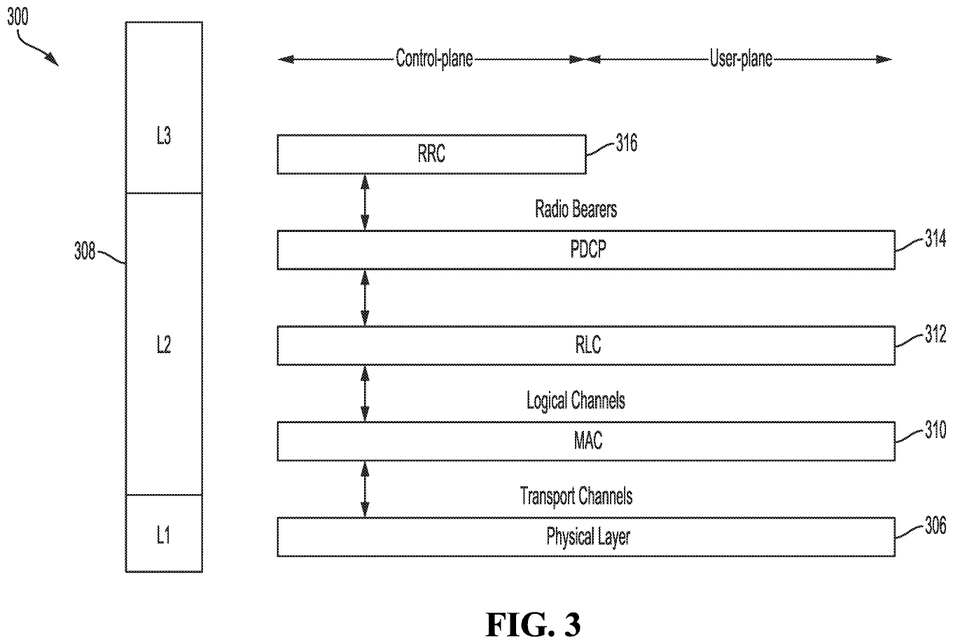

FIG. 3 is a diagram 300 illustrating an example of a radio protocol architecture for the user and control planes in LTE. The radio protocol architecture for the UE and the eNB is shown with three layers: Layer 1, Layer 2, and Layer 3. Layer 1 (L1 layer) is the lowest layer and implements various physical layer signal processing functions. The L1 layer will be referred to herein as the physical layer 306. Layer 2 (L2 layer) 308 is above the physical layer 306 and is responsible for the link between the UE and eNB over the physical layer 306.

In the user plane, the L2 layer 308 includes a media access control (MAC) sublayer 310, a radio link control (RLC) sublayer 312, and a packet data convergence protocol (PDCP) 314 sublayer, which are terminated at the eNB on the network side. Although not shown, the UE may have several upper layers above the L2 layer 308 including a network layer (e.g., IP layer) that is terminated at the PDN gateway 118 on the network side, and an application layer that is terminated at the other end of the connection (e.g., far end UE, server, etc.).

The PDCP sublayer 314 provides multiplexing between different radio bearers and logical channels. The PDCP sublayer 314 also provides header compression for upper layer data packets to reduce radio transmission overhead, security by ciphering the data packets, and handover support for UEs between eNBs. The RLC sublayer 312 provides segmentation and reassembly of upper layer data packets, retransmission of lost data packets, and reordering of data packets to compensate for out-of-order reception due to hybrid automatic repeat request (HARQ). The MAC sublayer 310 provides multiplexing between logical and transport channels. The MAC sublayer 310 is also responsible for allocating the various radio resources (e.g., resource blocks) in one cell among the UEs. The MAC sublayer 310 is also responsible for HARQ operations.

In the control plane, the radio protocol architecture for the UE and eNB is substantially the same for the physical layer 306 and the L2 layer 308 with the exception that there is no header compression function for the control plane. The control plane also includes a radio resource control (RRC) sublayer 316 in Layer 3 (L3 layer). The RRC sublayer 316 is responsible for obtaining radio resources (e.g., radio bearers) and for configuring the lower layers using RRC signaling between the eNB and the UE.

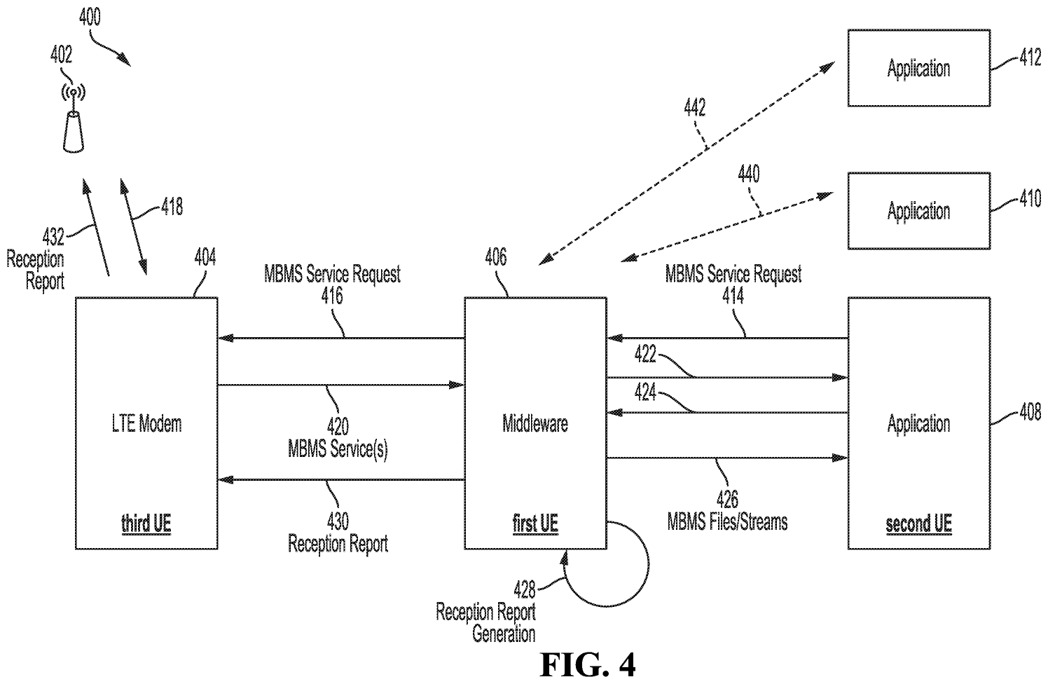

FIG. 4 is a diagram 400 illustrating an exemplary eMBMS end-to-end architecture. As shown in FIG. 4, a middleware client 406 running on a first UE may receive a request 414 for an MBMS service from an application 408 running on a second UE. The middleware client 406 may also receive additional requests 840, 842 for MBMS services from applications 410, 412 running on other UEs. The middleware client 406 may send an MBMS service request 416 to an LTE modem 404 of a third UE based on the received MBMS service requests 414, 840, 842. Specifically, in the MBMS service request 416, the middleware client 406 may request the same MBMS services that were requested in the MBMS service requests 414, 840, 842. The LTE modem 404 communicates 418 with the base station 402 to obtain the particular MBMS services, and then forwards 420 the received MBMS service(s) to the middleware client 406. The middleware client 406 informs 422 (e.g., through a short message service (SMS) text message) the application 408/second UE that MBMS services corresponding to the MBMS service request 414 have been received. The middleware client 406 may also inform the applications 410, 412 and/or their corresponding UEs that the requested MBMS services have been received. Upon receiving an indication 424 that the application 408 is ready to receive the MBMS files/streams of the MBMS services corresponding to the MBMS service request 414, the middleware client 406 sends the requested MBMS files/streams 426 to the application 408. The middleware client 406 may also send the requested MBMS files/streams to the application 410 and the application 412. Subsequently, the middleware client 406 generates a reception report 428 that includes a reception acknowledgement and/or a statistical report. The reception report may include a client identifier associated with the second UE or the application 408 running on the second UE. The middleware client 406 sends the reception report 430 to the LTE modem 404, which sends the reception report 432 to the base station 400.

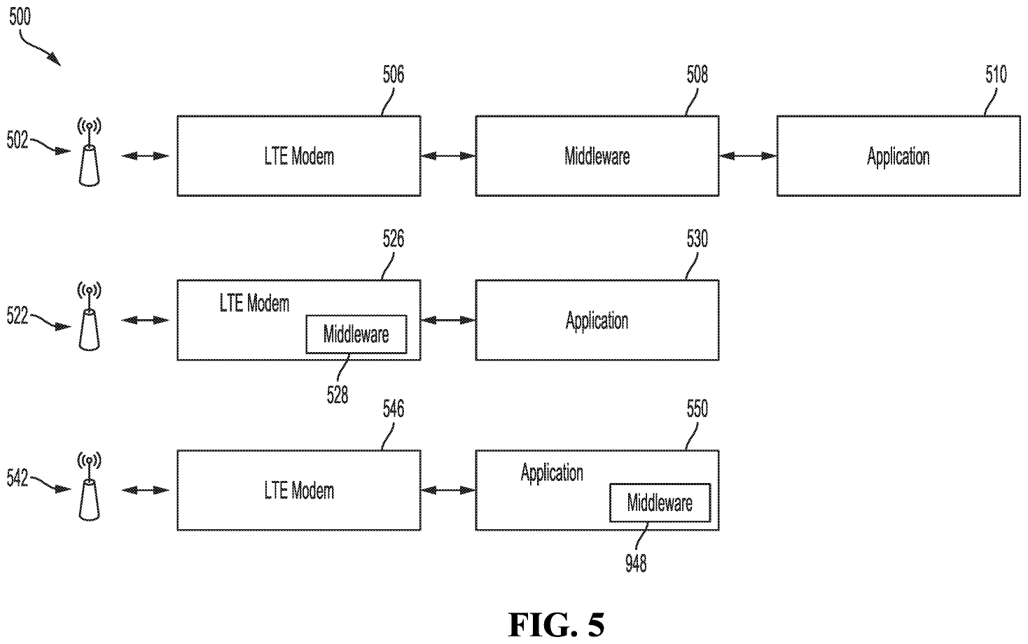

FIG. 5 is a diagram 500 illustrating different exemplary eMBMS end-to-end architectures. In a first configuration 502, the LTE modem 506, the middleware client 508, and the application 510 are associated with different UEs. In such a configuration, the middleware client 508 may run on a first UE, the application 510 may run on a second UE, and the LTE modem may be part of a third UE. In a second configuration 522, the middleware client 528 and the LTE modem 526 are associated with a first UE, and the application 530 is associated with a second UE. In such a configuration, the LTE modem 526 may be part of a first UE, the middleware client 528 may run on the first UE, and the application 530 may run on a second UE. In a third configuration 542, the middleware client 548 and the application 530 are associated with a first UE, and the LTE modem 546 is associated with a second UE. In such a configuration, the application 530 and the middleware client 548 run on a first UE, and the LTE modem 546 is part of a second UE. Accordingly, as can be seen by the first, second, and third configurations 502, 522, 542, respectively, the middleware client 508 may be associated with a UE different from UEs associated with the LTE modem 506 and the application 510 (first configuration 502), the middleware client 528 may be associated with the same UE as the LTE modem 526 (second configuration 522), or the middleware client 548 may be associated with the same UE as the application 530 (third configuration 542).

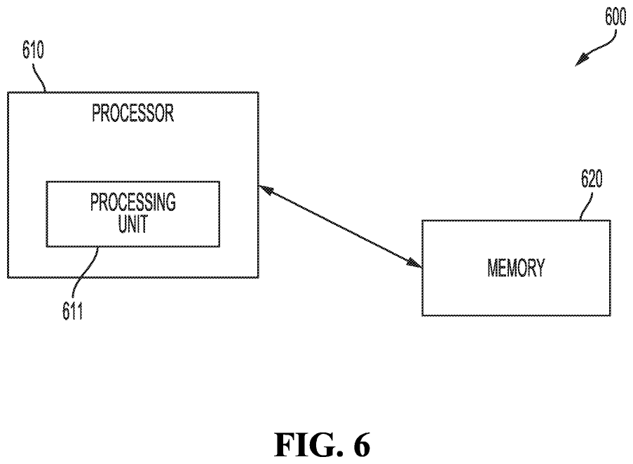

FIG. 6 is a schematic diagram illustrating components of a computing device 600, such as the user equipment 102, that can implement the embodiments described above. Computing device 600 that may be configured to enable and perform a smart notification. The computing device 600 may include a processor 610 and a memory 620. Various embodiments of the computing device 600 may include other circuits and/or components (not shown) such as various modems, a clock, a display component, various user interfaces, and transceivers configured to support the transmission and reception of messages.

In the MSDC or middleware described above, existing file delivery mechanisms may be re-used for various types of priority data. Priority data may include any data that must be treated with a high level of priority or quality of service due to its nature. Examples of priority data include mission-critical data such as public broadcast or security-related information for public safety. The MSDC may be implemented as software, firmware or a combination thereof in memory 620 to be executed by processor 610. The processor 610 may be an application processor and configured to perform functions such as service discovery, data distribution, and eMBMS service. Here, the MSDC may be configured for file recovery by using FLUTE+Raptor to recover mission-critical data files and deliver them to application.

Processor 610 may be dedicated hardware specifically adapted to perform various operations of the computing device 600, including, but not limited to, executing an operating system and/or various instances of one or more programs (i.e., processes). In some embodiments, the processor 610 may be or include a programmable processing unit 611 that may be programmed with processor-executable instructions to perform the various operations of the computing device 600. In some embodiments, the processor 610 may be a programmable microprocessor, microcomputer or multiple processor chip or chips that can be configured by software instructions to perform the various operations of the computing device 100. In some embodiments, the processor 610 may be a combination of dedicated hardware and a programmable processing unit 611.

In some embodiments, the memory 620 may store processor-executable instructions. In some embodiments, the memory 620 may be volatile memory, non-volatile memory (e.g., flash memory), or a combination thereof. In some embodiments, the memory 620 may include internal memory included in the processor 610, memory external to the processor 610, or a combination thereof. In some embodiments, the memory 620 may include volatile memory, such as a random access memory (RAM), in which an operating system and various instances of one or more programs (i.e., processes) may be executed by the processor 610.

While the various components of the computing device 600 are illustrated in FIG. 6 as separate components, some or all of the components may be integrated together in a single device such as a mobile device or phone, or a module, such as a system-on-chip module.

Various embodiments will now be described that may leverage existing middleware mechanisms for File Delivery and Streaming (as defined in TS 26.347), for example, through out-of-band signaling through GC1 (group communication Unicast control specification) or any other proprietary signaling. Here, the service announcement (USD) syntax may be used to create a partial service announcement file that is delivered to an application. The service announcement (SA) file describes service or services of interest to this application. In some embodiments, a service announcement file may be delivered from an application to the middleware. Here, the Service announcement file may describe one or more services. In some embodiments, the middleware parses partial service announcement file and makes services available on corresponding interface, e.g., FD service on FD interface, streaming service on streaming interface. In some embodiments, the service announcement is combined with global service announcement. Here, the service IDs are unique across SA files. In yet some embodiments, service clean-up may be implemented by which applications have the ability to delete passed services. The middleware ensures that applications can delete services that an application announces. In yet some embodiments, priority handling allows relative priority of group call services vs. FD services from group call application vs. streaming service from group call application vs. FD service announced by network vs. streaming service announced by network.

In one embodiment, a method for delivering mission-critical data on MBMS middleware comprises registering a mission-critical application with a file delivery interface of a MBMS middleware; delivering on a group communication interface or the file delivery interface or other interfaces, a service description file to the MBMS middleware; re-using an existing file delivery interface of MBMS middleware for accessing services listed in a provided service announcement file and for providing content carried by said services to the mission-critical data application. The mission-critical application may receive a service description of a file delivery service; and pass the received file delivery service description to a MBMS middleware. The mission-critical application may identify the mission-critical data service through an associated service ID. The service description file describing the mission-critical data services may be combined with a global service description. The group call services can be prioritized over other services. Also, past services that announced by the mission-critical applications may be deleted.

An apparatus for delivering mission-critical data on MBMS middleware comprises means for registering a mission-critical application with a file delivery interface of a MBMS middleware; means for delivering a service description file to the MBMS middleware; means for re-using an existing file delivery interface of MBMS middleware for accessing services listed in a provided service announcement file and for providing content carried by said services to the mission-critical data application. The apparatus may be a computing device or a processor.

The eMBMS Service Layer Feature Set includes various features. For example, service discovery includes bootstrapping (discovering service announcement channel access information) and service announcement reception. For example, streaming includes DASH content delivery over file delivery service. For example, file download includes application content delivery over file delivery service. For example, group communication includes delivery of group call downlink data. For example, associated delivery procedure (ADP) includes file repair (method to complete/capture download of partially received files) and reception reporting (method to capture and report QoE metrics).

It will be appreciated that 3GPP eMBMS defines two different delivery methods: download delivery (file delivery services) using the FLUTE protocol as defined in RFC 3926 and streaming delivery, where 3GPP allows for DASH over FLUTE as one of the streaming methods and RTP is not used in various LTE broadcast solution.

It will be appreciated that application layer FEC is referenced in FLUTE. The 3GPP eMBMS standard specifies two mandatory modes for FEC: No code FEC and Raptor 10 FEC scheme for object delivery is defined in RFC 3053. Dynamic Adaptive Streaming over HTTP (DASH) is a multimedia streaming protocol that enables the delivery of multimedia content from a standard HTTP server to a HTTP client (DASH client). DASH is defined in MPEG DASH ISO/IEC 23009-1:2014/Cor 1:2015 and ISO/IEC 23009-1:2014/Amd 1:2015. A multimedia file is split into segments and each segment is delivered over HTTP. Media presentation description (MPD) provides URLs, timing information, and media characteristics such as bitrate and resolution. MSDC uses DASH over FLUTE and enables DASH access via unicast when not in coverage. With eMBMS, the MSDC acts like a local DASH server. The MSDC can keep a buffer of the live stream allowing pause/rewind functionality. DASH is time-sensitive and needs accurate UTC time from the underlying platform.

The group communication delivery method is defined in 3GPP TS 26.346. The service layer implements the group communication interface. An application activates bearer by specifying the bearer TMGI. MSDC provides coverage indications, service area identifier updates, and the reception status of bearer. Application accesses bearer content by opening multicast IP socket.

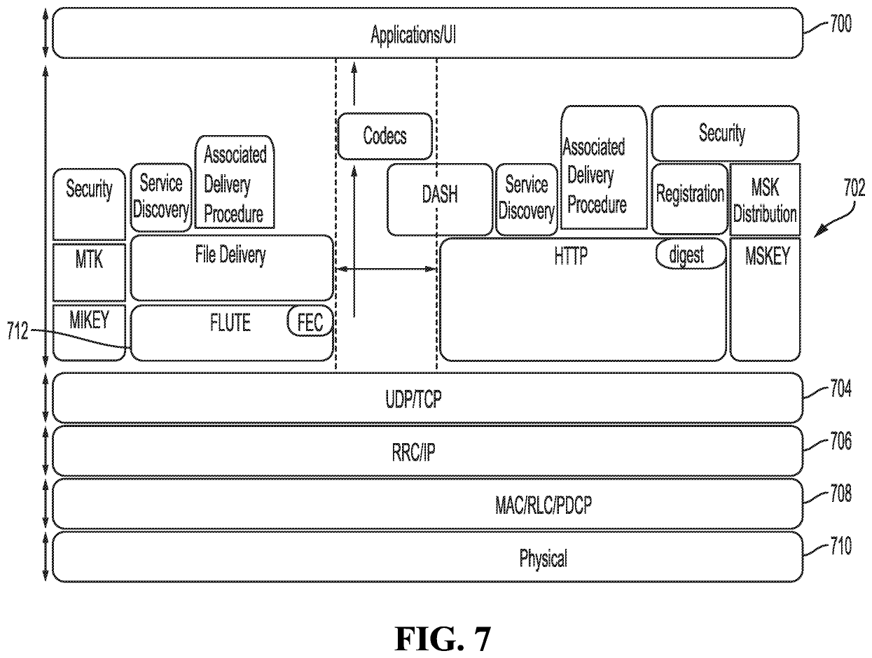

FIG. 7 illustrates example eMBMS Protocol Layers in an exemplary device. It will be appreciated that broadcast communications operates in parallel to unicast. Upper layers 700 may connect to applications and standards-based codecs (e.g. TS 26.346). Intermediate layers 702 may be IETF protocols, e.g., device connects to web and uses HTML. Lower layers 704, 706, 708, and 710 are defined by 3GPP, e.g., physical and MAC.

The middleware supports a Group Communication interface that enables an application to activate a TMGI and receive the IP packets delivered over the corresponding bearer. It will be appreciated that the middleware is not on the data path. Thus, the application reads the packets directly from a multicast IP socket.

In some embodiments, the existing FLUTE/RAPTOR delivery mechanisms 712 may be leveraged for delivering mission-critical data (MC Data) files. The group communication interface extends to allow the middleware to accept a partial SA file describing a FD service for MC data, and leverage the existing middleware implementation for file recovery by using FLUTE+Raptor to recover MC Data files and deliver them to application.

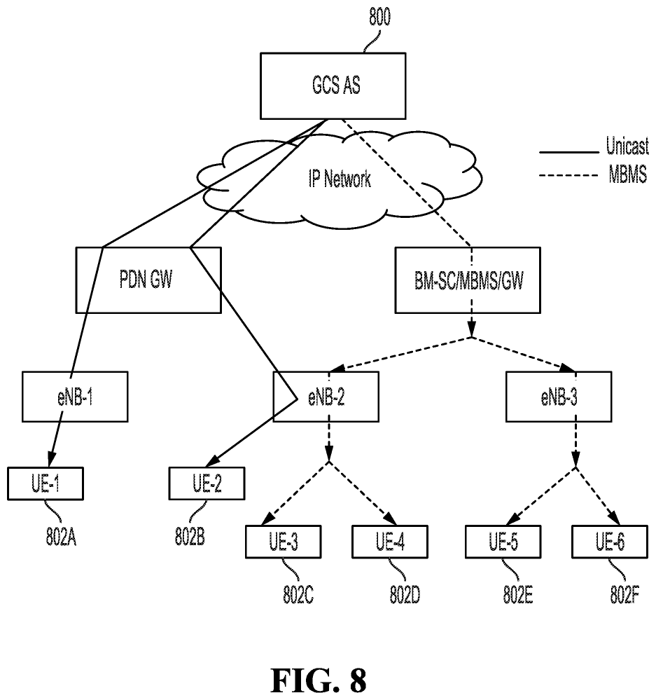

FIG. 8 illustrates an example network architecture. Group calls may be established between a group call system application server (GCS AS) 800 and one or more end devices 802A, 802B, 802C, 802D, 802E, an 802F. Each end device may include a group call client as discussed herein. The downlink group call or data communication between the GCS and the UE may switch between UC and BC. GC1 interface between server and client is SIP based and is defined in R13 by the CT1 group (see e.g. 3GPP 24.379).

Some embodiments described allows reuse of the existing mechanisms defined in 3GPP Spec 26.346 including broadcast delivery over FLUTE, session signaling through a service announcement, recovery through unicast fallback, through file repair, reception reporting, etc.

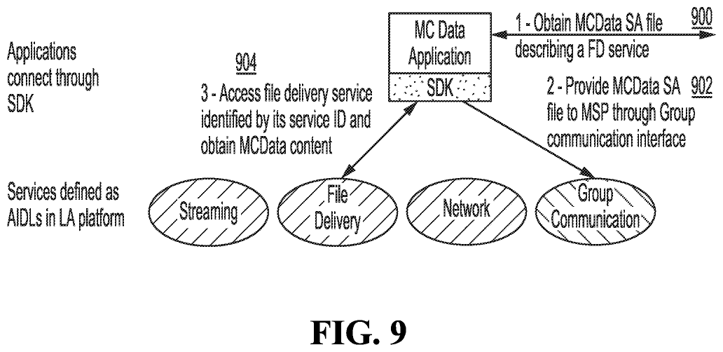

FIG. 9 illustrates an example process supporting the priority data transfer as discussed. In one example, a mission-critical (MC) Data application connects to both a group communication and a file delivery interface. It will be appreciated that a software development kit (SDK) may be accessible to the MC Data Application and allow connections to the depicted components. The MC Data application may implement the following:

In step 900, the application obtains a well formed service announcement (SA) file describing a file delivery (FD) service. The service announcement file may be as discussed herein. It will be appreciated that the service announcement file may describe other services besides the file delivery service provided by the system.

In step 902, the application passes the MCData SA file to the Mobile Service Providers (MSP) over the group communication interface. For example, the group communication interface may utilize a communications protocol as discussed herein. The MSP may then parse the received SA file. The FD services described in the SA file are added to the service list. Existing services are typically not affected.

In step 904, the application obtains the list of services on the FD interface and identifies the service of interest. In this example, the service of interest is the file delivery service. The application can now initiate capture operations on the service via a file transfer interface as discussed. Files and other content may be captured directly from the interface. As will be appreciated, this embodiment does not require the middleware to be on the data path. In other examples, the file or content may be held for subsequent or asynchronous capture by the application if a communications link is disrupted or temporarily unavailable.

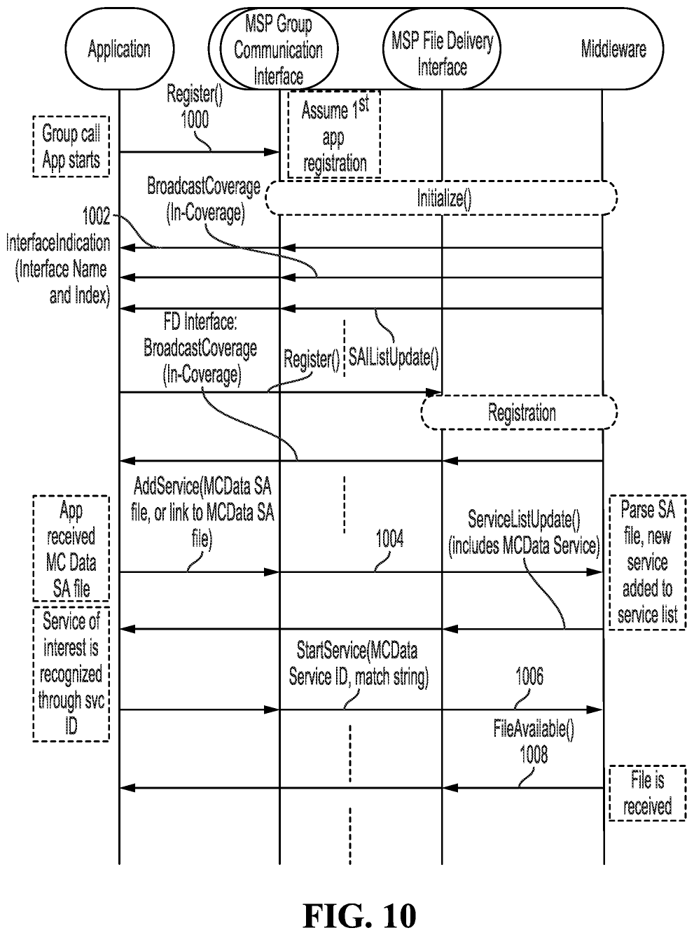

FIG. 10 illustrates an example call flow as discussed herein. In step 1000, the application registers both the group communication interface and the file delivery interface with the MSP group communication interface. In one example, this may be assumed to be the first registration by the application. This may lead to initialization at the MSP file delivery interface and a MBMS middleware. This step may be initiated by a start of a group call application on user equipment.

In step 1002, the application receives the service description of a FD service from the MSP group communication interface. The SA file may be constructed in accordance to a service discovery profile as discussed. Furthermore, reception reporting and file repair may be supported by the application. The application may also receive an interface name and index associated with the interface.

Other actions in this step may include confirming broadcast coverage of the file delivery interface and registering of relevant information at the MSP file delivery interface and middleware. In one example, it may be determined that the user equipment is no longer in coverage, whether by proximity or through service disruptions.

In step 1004, the application reviews the received MC Data and SA file. It may request to add the service as described in the MC Data SA File, or via a link. The MSP parses the SA file and adds the MC service to the service list. This may be accomplished at the middle ware. In response, a service list update function is called to include the MC Data service as registered. At this point, the service of interest may be recognized at the application by its service ID.

In step 1006, the application identifies the MCData service through the associated service identifier. The application may request the service be started with parameters MC Data Service ID and a matching string. For example, the matching string may include a file or content identifier of a requested file or content.

In step 1008, a requested file or content is received. A notification may be sent to the application. The file may be made available to the application. The application initiates a capture on the MC Data service of interest. This may include the requested priority data.

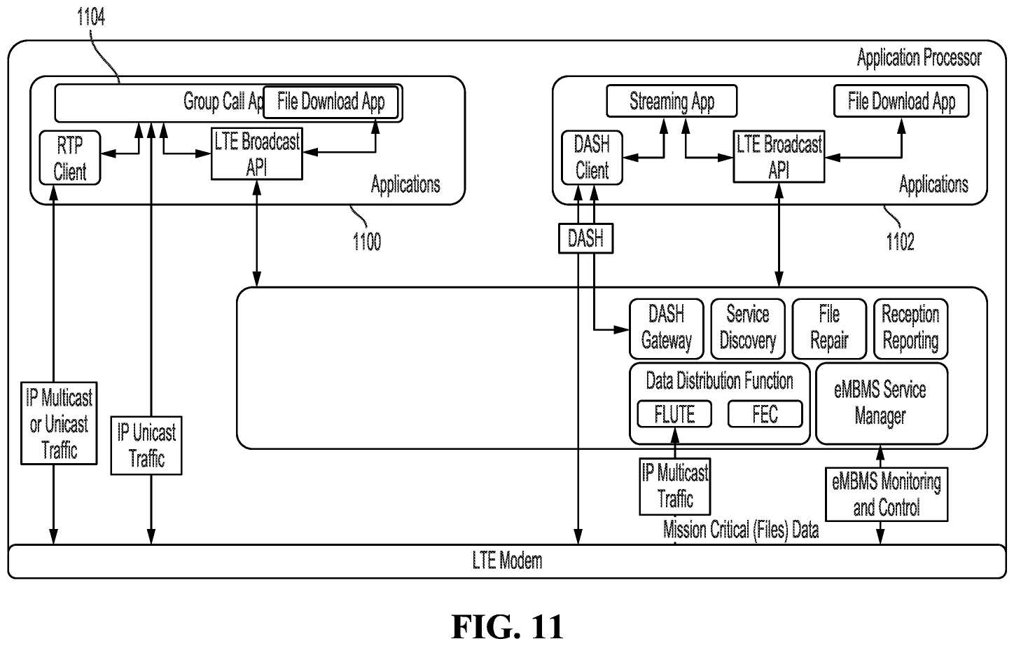

FIG. 11 illustrates an example Multicast Services Device Client (MSDC) interface for handling Group Calls. As illustrated, LTE Broadcast APIs 1100 and 1102 provide various functionality for group calls. Here, the APIs 1100 and 1102 provides a set of functions 1104 for activating/deactivating and monitoring the status of group calls in particular, and the broadcast channel in general. This includes monitoring and control interface including the radio interface. This includes IP Multicast traffic including multicast UDP/IP data path per 3GPP 26.346 transport protocol specification delivering Downlink RTP traffic for the group call. This includes IP Unicast traffic, including control information between group call application and group call application server per 3GPP 24.379, uplink RTP traffic, and downlink RTP traffic when broadcast is not available.

Service List Handling, Concurrency and Clean-Up

In some embodiments, the network may only support group calls and MCData. The services in the USD are those obtained from the group communication application(s). However, generally, the network may support group calls and MCData, as well as ST and FD services as follows.

The services in the USD may include a mixed combination of services obtained through the FD and ST SA file (obtained from the SDCH or through unicast service discovery), as well as the services obtained from the group communication application(s).

It will be appreciated that the system may ensure unique service identifiers (IDs) across the 2 types of services. Various implementation methods may be used by the infrastructure.

Further, ability to cleanup added services from service list may be implemented as one of the following:

Alternative 1: remove FD services added by application on app deregistration from group communication interface.

Alternative 2: use short validity durations for the added services.

Alternative 3: application cleans up the added service through a delete Service function, for example.

Priority Handling and Service ID Uniqueness Issues

Priority assignment for MCData TMGIs may be implemented in various ways. For example, MCData TMGI may be lower than group communication TMGIs, but higher than regular ST and FD TMGIs. If used for mission-critical data, then priority of file delivery services announced through group call application may be prioritized over FD and streaming services announced through regular service announcement on SDCH or through unicast. If the use case is not for mission-critical data, then priority may be made equal to services of same type regardless of how they are announced. Here, it would be good to have a service ID assignment scheme for MCData services that does not conflict with service IDs in the USD covering ST and FD services.

The foregoing method descriptions and the process flow diagrams are provided merely as illustrative examples, and are not intended to require or imply that the operations of the various embodiments must be performed in the order presented. As will be appreciated by one of skill in the art, the operations in the foregoing embodiments may be performed in any order. Words such as “therefore,” “then,” “next,” etc. are not intended to limit the order of the operations; these words are simply used to guide the reader through the description of the methods. Further, any reference to claim elements in the singular, for example, using the articles “a,” “an,” or “the” is not to be construed as limiting the element to the singular.

As used in this application, the terms “component,” module,” “system,” and the like are intended to include a computer-related entity, such as, but not limited to hardware, firmware, a combination of hardware and software, software, or software in execution, which are configured to perform particular operations or functions. For example, a component may be, but is not limited to, a process running on a processor, a processor, an object, an executable, at thread of execution, a program, and/or a computer. By way of illustration, both an application running on a computing device and the computing device may be referred to as a component. One or more components may reside within a process and/or thread of execution, and a component may be localized on one processor or core and/or distributed between two or more processor or cores. In addition, these components may execute from various non-transitory computer readable media having various instructions and/or data structures stored thereon. Components may communicate by way of local and/or remote process, functions or procedure calls, electronic signals, data packets, memory read/writes, and other known network, computer, processor, and/or process related communication methodologies.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks modules, circuits, ad operations have been described above generally in terms of their functionality. Whether such functionality is implemented as hardware or software depends upon the particular application and design constrains imposed on the overall system. Skilled artisans may implement the described functionality in varying ways for each particular application, but such implementation decisions should not be interpreted as causing a departure from the scope of the claims. The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiment shown herein but is to be accorded the widest cope consistent with the following claims and principles and novel features disclosed herein.

What is claimed is:

1. A method for receiving priority data at an application, the method comprising:
receiving a first service announcement file from a Multimedia Broadcast Multicast Service (MBMS) middleware, the first service announcement file describing services of interest to the application including a file delivery service;
providing a second service announcement file to the MBMS middleware, the second service announcement file describing at least one service provided by the application including a file delivery interface;
requesting to register the application, the file delivery interface, and the file delivery service at the MBMS middleware; and
directly providing content delivered by the file delivery service received at the file delivery interface to the application.

2. The method of claim 1, wherein the file delivery service is associated with a mission-critical data service through an associated service identifier.

3. The method of claim 2, further comprising:
providing a service list to the MBMS middleware, the service list including the mission-critical data service; and
requesting, by the application, files of interest for subsequent download and delivery via the mission-critical data service.

4. The method of claim 2, further comprising:
combining the service list with the first service announcement file and the second service announcement file into a global service announcement; and
providing the global service announcement to the MBMS middleware.

5. The method of claim 1, further comprising:
providing the file delivery service with higher-priority service level over other services provided by the application and the MBMS middleware.

6. The method of claim 5, wherein the content is received from a multicast IP socket associated with the file delivery interface and a group call client.

7. The method of claim 1, wherein the MBMS middleware supports a group call system application server.

8. The method of claim 1, further comprising:
responsive to determining an associated expiry time has elapsed, requesting to unregister the application, the file delivery interface, and the file delivery service at the MBMS middleware.

9. An apparatus for receiving priority data at an application, the apparatus comprising:
a memory for storing the application;
a communications interface in communication with a Multimedia Broadcast Multicast Service (MBMS) middleware; and
a processor coupled to the memory and the communications interface, the processor configured to,
receive a first service announcement file from the MBMS middleware, the first service announcement file describing services of interest to the application including a file delivery service,
provide a second service announcement file to the MBMS middleware, the second service announcement file describing at least one service provided by the application including a file delivery interface,
request to register the application, the file delivery interface, and the file delivery service at the MBMS middleware, and
directly providing content delivered by the file delivery service received at the file delivery interface to the application.

10. The apparatus of claim 9, wherein the file delivery service is associated with a mission-critical data service through an associated service identifier.

11. The apparatus of claim 10, the processor further configured to,
provide a service list to the MBMS middleware, the service list including the mission-critical data service, and
request, by the application, files of interest for subsequent download and delivery via the mission-critical data service.

12. The apparatus of claim 10, the processor further configured to,
combine the service list with the first service announcement file and the second service announcement file into a global service announcement, and
provide the global service announcement to the MBMS middleware.

13. The apparatus of claim 9, the processor further configured to,
provide the file delivery service with higher-priority service level over other services provided by the application and the MBMS middleware.

14. The apparatus of claim 13, wherein the content is received from a multicast IP socket associated with the file delivery interface and a group call client.

15. The apparatus of claim 9, wherein the MBMS middleware supports a group call system application server.

16. The apparatus of claim 9, the processor further configured to,
responsive to determining an associated expiry time has elapsed, request to unregister the application, the file delivery interface, and the file delivery service at the MBMS middleware.

17. An apparatus for receiving priority data at an application, the apparatus comprising:
a memory means for storing the application;
a communications interface means in communication with a Multimedia Broadcast Multicast Service (MBMS) middleware; and
a processor means coupled to the memory and the communications interface, the processor configured to,
receive a first service announcement file from the MBMS middleware, the first service announcement file describing services of interest to the application including a file delivery service,
provide a second service announcement file to the MBMS middleware, the second service announcement file describing at least one service provided by the application including a file delivery interface,
request to register the application, the file delivery interface, and the file delivery service at the MBMS middleware, and
directly providing content delivered by the file delivery service received at the file delivery interface to the application.

18. The apparatus of claim 17, wherein the file delivery service is associated with a mission-critical data service through an associated service identifier.

19. The apparatus of claim 18, the processor means further configured to,
provide a service list to the MBMS middleware, the service list including the mission-critical data service, and
request, by the application, files of interest for subsequent download and delivery via the mission-critical data service.

20. The apparatus of claim 18, the processor means further configured to,
combine the service list with the first service announcement file and the second service announcement file into a global service announcement, and
provide the global service announcement to the MBMS middleware.

21. The apparatus of claim 17, the processor means further configured to,
provide the file delivery service with higher-priority service level over other services provided by the application and the MBMS middleware.

22. The apparatus of claim 21, wherein the content is received from a multicast IP socket associated with the file delivery interface and a group call client.

23. The apparatus of claim 17, wherein the MBMS middleware supports a group call system application server.

24. The apparatus of claim 17, the processor means further configured to,
responsive to determining an associated expiry time has elapsed, request to unregister the application, the file delivery interface, and the file delivery service at the MBMS middleware.

25. A non-transitory computer-readable storage medium having stored thereon instructions that, when executed, cause one or more processors to perform a process comprising:
receiving a first service announcement file from a Multimedia Broadcast Multicast Service (MBMS) middleware, the first service announcement file describing services of interest to the application including a file delivery service;
providing a second service announcement file to the MBMS middleware, the second service announcement file describing at least one service provided by the application including a file delivery interface;
requesting to register the application, the file delivery interface, and the file delivery service at the MBMS middleware; and
directly providing content delivered by the file delivery service received at the file delivery interface to the application.

26. The medium of claim 25, wherein the file delivery service is associated with a mission-critical data service through an associated service identifier.

27. The medium of claim 26, the process further comprising:
providing a service list to the MBMS middleware, the service list including the mission-critical data service;
requesting, by the application, files of interest for subsequent download and delivery via the mission-critical data service;
combining the service list with the first service announcement file and the second service announcement file into a global service announcement; and
providing the global service announcement to the MBMS middleware.

28. The medium of claim 25, the process further comprising:
providing the file delivery service with higher-priority service level over other services provided by the application and the MBMS middleware, wherein the content is received from a multicast IP socket associated with the file delivery interface and a group call client.

29. The medium of claim 25, wherein the MBMS middleware supports a group call system application server.

30. The medium of claim 25, the process further comprising:
responsive to determining an associated expiry time has elapsed, requesting to unregister the application, the file delivery interface, and the file delivery service at the MBMS middleware.
